(19) United States
(12) Patent Application Publication
(10) Pub. No.: US 2005/0073523 A1
(43) Pub. Date: Apr. 7, 2005

(54) Display unit, and apparatus having a display function

(75) Inventor: Toshiji Kubota, Tokyo (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/952,623

(22) Filed: Sep. 28, 2004

(30) Foreign Application Priority Data
Oct. 7, 2003 (JP) 2003-348096

(51) Int. Cl. G06T 11/00

(52) U.S. Cl. 345/467; 345/471

(57) ABSTRACT

A display unit includes a display section for displaying a character font. The display unit includes different memories for storing different character fonts, a selecting-signal input unit for inputting a selecting signal for selecting one character font from among the different character fonts, and a display-control unit for controlling the display section to display the character font selected by the selecting-signal input unit based on the selecting signal input. By using common components and improving productivity, the cost required for producing the display unit and a display-function apparatus including the display unit can be reduced. Furthermore, the display unit has a reduced processing load on a CPU.

### CROSS REFERENCE TO RELATED APPLICATIONS

This application claims priority from Japanese Patent Application No. 2003-348096 filed on Oct. 7, 2003, which is hereby incorporated by reference herein.

### BACKGROUND OF THE INVENTION

1. Field of the Invention

The present invention relates to a display unit having a display section for displaying a character font, and an apparatus having a display function.

2. Description of the Related Art

FIG. 7 is a block diagram showing a display unit 200 of the related art.

The display unit 200 of the related art is a multi-function peripheral (MFP) unit. The MFP unit is a computer peripheral device that is used while connected to a computer 1 or a network, and operates in response to control commands from the computer 1 or the network.

When no control command is received from the computer 1 or the network, and the main part of the MFP unit receives a key-input signal (from a key-input unit 6), the MFP unit functions alone.

A computer interface 2 acquires control commands from the computer 1 and constantly performs a data-interface operation between MFP units, such as exchanging MFP-status information.

A central processing unit (CPU) 3 constantly analyzes the control commands and drives a scanner unit 4, a printer unit 5, and a display module 7.

FIG. 8 is a detailed block diagram showing the display module 7 (in the display unit 200) shown in FIG. 7.

When receiving a reading-control command from the computer 1 through the computer interface 2, the CPU 3 drives the display module 7 to display an operation status to a user, and simultaneously drives a charge-coupled device and light source of the scanner unit 4 to read a document. The CPU 3 transmits information of the read document to the computer 1 through the computer interface 2.

The printer unit 5 is a recording device such as an inkjet printer or a laser beam printer. When the CPU 3 receives an input recording-control command and recording data from the computer 1 through the computer interface 2, it drives the display module 7 to display an operation status to the user, and drives the printer unit 5 to record the received data on recording paper.

As shown in FIG. 8, the display module 7 includes a CPU interface 71, an instruction register 72, a data register 73, an address counter 74, a timing generating circuit 75, a display data RAM (random access memory) 76, a character generator CG3, a liquid crystal display (LCD) driver circuit 79, and an LCD unit 80.

The CPU interface 71 exchanges commands and display data with the CPU 3.

The instruction register 72 stores instruction codes, such as a display-clear code, and address information of the display data RAM 76.

When the CPU 3 writes a control command and display data (from the display unit 200) in the CPU interface 71, the instruction register 72 analyzes the received control command for the LCD unit 80. Based on the result of analysis, the CPU 3 operates related units in the display module 7 to display a picture on the LCD unit 80.

In the data register 73, data to be written into the display data RAM 76 is received and stored. The data written in the data register 73 by the CPU 3 is automatically written in the display data RAM 76.

The address counter 74 is used to supply addresses of the display data RAM 76 and the character generator CG3.

When an address instruction is written in the instruction register 72, address information is transferred from the instruction register 72 to the address counter 74.

The display data RAM 76 stores display data represented by an eight-bit character code. An address in the display data RAM 76 is designated by an address output from the address counter 74.

FIG. 9 is a table showing addresses of the display data RAM 76, and character data items stored at the addresses.

Display-position address 00 corresponds to a left display digit on the screen of the LCD unit 80. The subsequent display-position addresses correspond to display digits of the LCD unit 80.

The character generator CG3 is a ROM (read-only memory) for generating an LCD display pattern based on an eight-bit character code, and is a ROM storing a display font for the LCD unit 80 which corresponds to the character code.

FIG. 10 is a table showing, in the display unit 200 of the related art, addresses in the character generator CG3, character codes input to a font-data array, and display font characters that are output from the character generator CG3 correspondingly to the character codes.

A character code is input as an address in the character generator CG3. Accordingly, for example, in order for the character generator CG3 to output the display-font character non, character code “00H2” is input. The input character code is replaced by a corresponding address, and the display-font character “0” to be stored at address “00” is output from the character generator CG3.

The timing generating circuit 75 generates timing signals for operating the display data RAM 76, the LCD unit 80, the character generator CG3, etc.

In response to the timing signal from the timing generating circuit 75, the driver circuit 79 and the data register 73 output, to the LCD unit 80, LCD-display font data output from the character generator CG3.

Display by the LCD unit 80 is controlled by the driver circuit 79 and the output of the data register 73.

For example, as shown in FIG. 9, when displaying the characters “2013” in the order given from the left on the LCD unit 80, at first, the CPU 3 writes, in the CPU interface 71 of the display unit 200, an address command representing the display position 00 and the character data 02H corresponding to “2”.

Next, the instruction register 72 sets the address 00 in the address counter 74 by using the address command for the display position 00 corresponding to “2”.

Next, after passing through the data register 73, the character code 02H corresponding to “2” is stored at the address 00 in the display data RAM 76 which is indicated by the address counter 74.

Next, in order to display the character “0”, the CPU 3 writes, in the CPU interface 71 in the display unit 200, an address command representing the display position 01. The instruction register 72 sets the address 01 in the address counter 74 by using the address command representing the display position 01.

Next, the CPU 3 writes, in the CPU interface 71 in the display unit 200, the character code 00H corresponding to “0”. After passing through the data register 73, the character code 00H corresponding to “0” is stored at the address 01 of the display data RAM 76 which is indicated by the address counter 74.

Up to the character code 03H representing “3” which is to be displayed at the display position 03, similar processing is performed. In this processing, the character codes 02H, 00H, 01H, and 03H respectively corresponding to “2”, “0”, “1”, “3” are written at addresses 00 to 03, respectively, of the display data RAM 76.

With LCD display timing, the timing generating circuit 75 generates timing signals for operating the address counter 74, the display data RAM 76, and the character generator CG3.

This allows the display data RAM 76 to sequentially output, to the character generator CG3, the character codes 02H, 00H, 01H, and 03H respectively corresponding to “2”, “0”, “1”, “3”,

The character generator CG3 generates LCD display patterns corresponding to the character codes and outputs the LCD display patterns to the driver circuit 79 (and the data register 73).

In response to the timing signal from the timing generating circuit 75, each of the driver circuit 79 and the data register 73 outputs, to the LCD unit 80, the LCD display font data output from the character generator CG3. This displays the characters “2013” on the screen of the LCD unit 80.

In a system for displaying other languages on the LCD unit 80, display-language character fonts are stored in a rewritable program ROM provided outside an LCD control module. When switching displayed languages, display characters in the rewritable program ROM are rewritten.

The MFP unit of the related art, which displays characters by using the character generator CG3 built into the display module 7, includes only a character generator ROM for displaying one type of language. In addition, this MFP unit does not have any display-language switching function for the character generator CG3. Accordingly, a display module and an MFP unit must be produced for each display language.

In a method of the related art for rewriting display characters in the rewritable ROM, the use of an expensive flash memory greatly increases the production cost. In addition, an operation of rewriting font data requires considerable time, thus increasing the production cost.

When a ROM storing a plurality of languages is provided outside the LCD unit 80, the CPU 3 must create all image data for each displayed screen. This causes a large processing load the CPU 3.

### SUMMARY OF THE INVENTION

The present invention provides a display unit in which the cost required for production can be reduced by using common components and improving productivity and in which a processing load on a central processing unit can be reduced, and an apparatus having a display function, which includes the display unit.

According to an aspect of the present invention, a display unit including a display section for displaying a character font is provided. The display unit includes: a plurality of different memories, with each memory storing a different character font, a selecting-signal input unit for inputting a selected input signal for selecting one character font from among the character fonts, and a display-control unit for controlling the display section to display the character font selected by the selecting-signal input unit based on the selected input signal.

The display-control unit may control the display section to switch the selected character font to a different character font and to display the different character font.

According to another aspect of the present invention, an apparatus including a display section for displaying a character font is provided. The apparatus includes: a plurality of different read-only memories, with each read-only memory storing a different character font, a memory selecting unit for selecting one read-only memory from among the different read-only memories, and a display-section control unit for controlling the display section to read the character font stored in the read-only memory selected by the memory selecting unit and to display the read character font.

The display-section control unit may control the display section to switch the read character font to a different character font in response to selection by the memory selecting unit and to display the different character font.

Further features and advantages of the present invention will become apparent from the following description of the preferred embodiments with reference to the attached drawings.

### BRIEF DESCRIPTION OF THE DRAWINGS

FIG. 1 is a block diagram showing a display unit.

FIG. 2 is a table showing the arrangement of addresses and font-data items in a second character generator memory CG2.

FIG. 3 is a flowchart illustrating a process in which a CPU (in the display unit) shown in FIG. 1 sets up a display module (shown in FIG. 1) in response to an input from a key-input unit shown in FIG. 1.

FIG. 4 is a flowchart illustrating an internal operation of the display module.

FIG. 5 is a flowchart illustrating an LCD display process, that is, a process in which the CPU writes font data in the display module.

FIG. 6 is an illustration of the status of display data RAM and font displayed on a liquid crystal display unit (in the case of alphabetic display setting).

FIG. 7 is a block diagram showing a display unit of the related art.

FIG. 8 is a block diagram showing a specific example of a display module (shown in FIG. 7) in the display unit of the related art.

FIG. 9 is a table showing addresses in the display data RAM and displayed character-data items that are stored in the addresses.

FIG. 10 is a table showing, in the display unit of the related art, addresses in the character generator, character codes input to a font data array, and display font characters output from the character generator correspondingly to the character codes.

### DESCRIPTION OF THE EMBODIMENTS

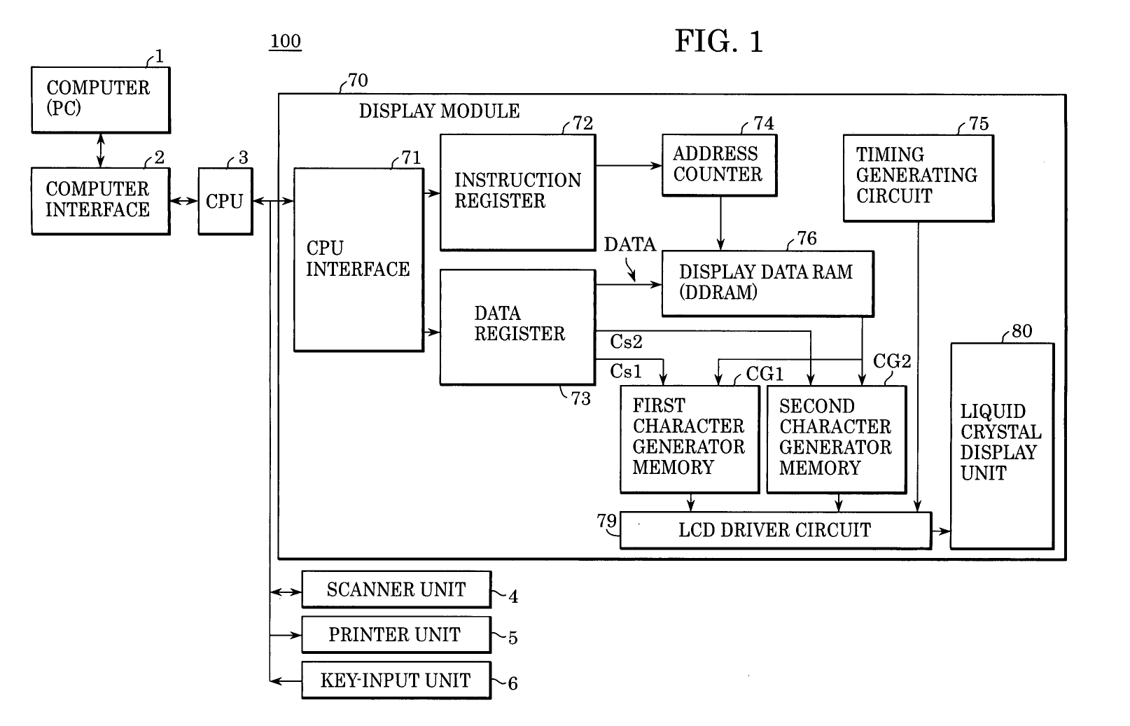

FIG. 1 is a block diagram showing a display unit 100 according to an exemplary embodiment of the present invention.

The display unit 100 includes a computer 1, a computer interface 2, a CPU 3, a scanner unit 4, a printer unit 5, a key-input unit 6, and a display module 70.

The display module 70 includes a CPU interface 71, an instruction register 72, a data register 73, an address counter 74, a timing generating circuit 75, a display data RAM 76, a first character generator memory CG1, a second character generator memory CG2, an LCD driver circuit 79, and a liquid crystal display unit 80.

In the display module 70, the CPU interface 71, the instruction register 72, the data register 73, the address counter 74, the timing generating circuit 75, the display data RAM 76, the LCD driver circuit 79, and the liquid crystal display unit 80 are similar to those used in the display unit 200 of the related art and described above, therefore, no further descriptions are provided here.

The first character generator memory CG1 and the second character generator memory CG2 are LCD-display-character generator memories.

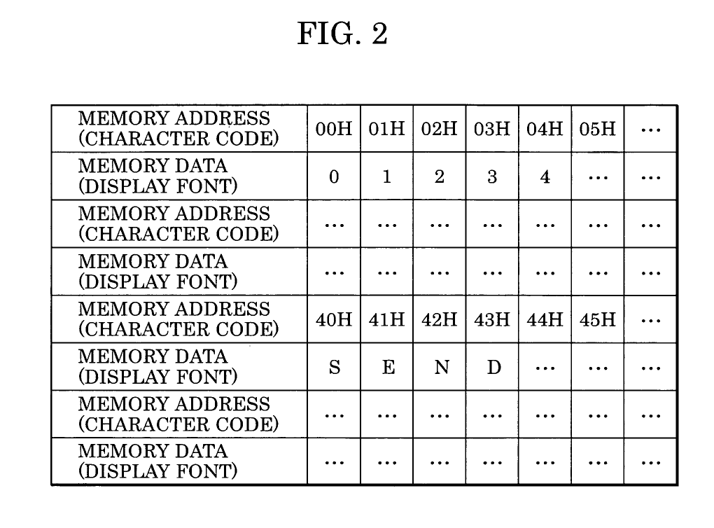

FIG. 2 shows an arrangement of addresses and font data in the second character generator memory CG2.

As shown in FIG. 2, the second character generator memory CG2 stores alphabet font data.

A case in which the English language is set as a display language in the second character generator memory CG2 and alphabet letters are displayed by the second character generator memory CG2 is described next.

A “SEND” display operation in which display setting in the liquid crystal display unit 80 is configured for an alphabet by the key-input unit 6 and the display module 70 uses an alphabet font to display “SEND” (representing transmission), is described below.

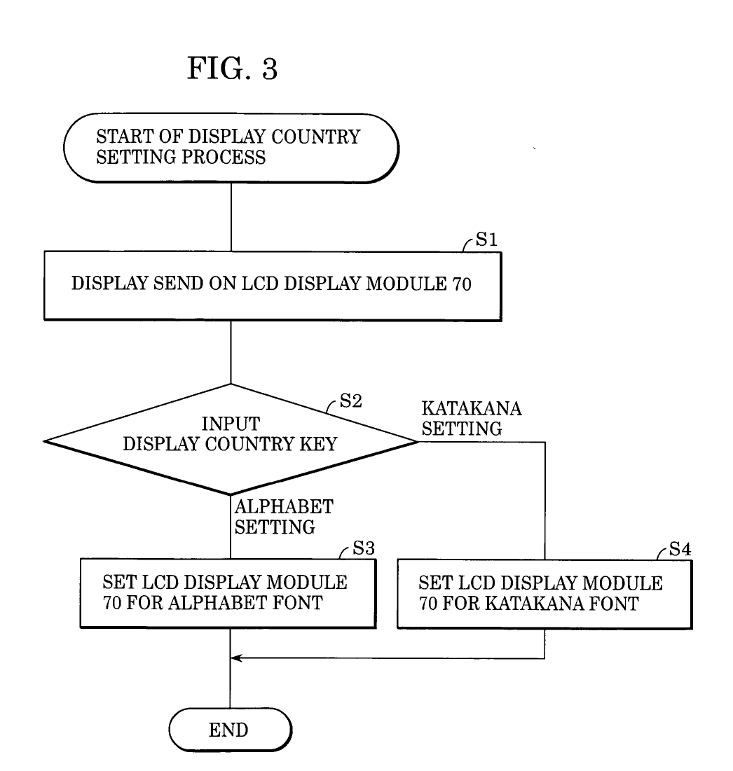

FIG. 3 is a flowchart illustrating a process in which the CPU 3 (in the display unit 100) shown in FIG. 1 sets up a display module 70 (shown in FIG. 1) in response to an input from the key-input unit 6 shown in FIG. 1. First, in step S1, “SEND” is displayed on the display module 70. A country key setting (display language) is configured. Further processing is based on the country key setting as determined in step S2. In the example shown in FIG. 3, if the country key setting is an alphabet setting, processing proceeds to step S3 and if the country key setting is a katakana setting, processing proceeds to step S4. After the display module 70 has been set for the desired font (e.g., alphabet font in step S3 or katakana font in step S4), processing of FIG. 3 ends.

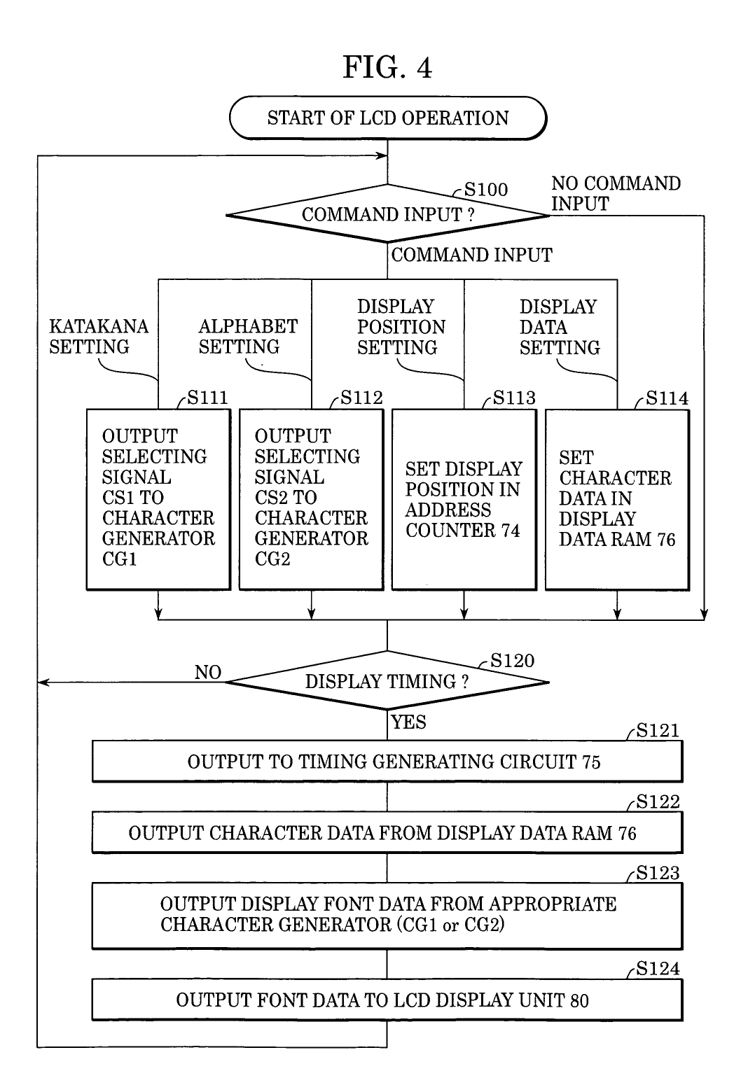

FIG. 4 is a flowchart illustrating an internal operation of the display module. In the example described herein, the country key setting is alphabet. At step S100, it is determined whether a command has been input. If it is determined that a command has been input (yes in step S100), appropriate processing is performed based on the setting (set mode). For example, if the set mode is alphabet, in response to the set mode (country key setting), the display module 70 outputs a selecting signal CS2 for selecting the second character generator memory CG2 in step S112.

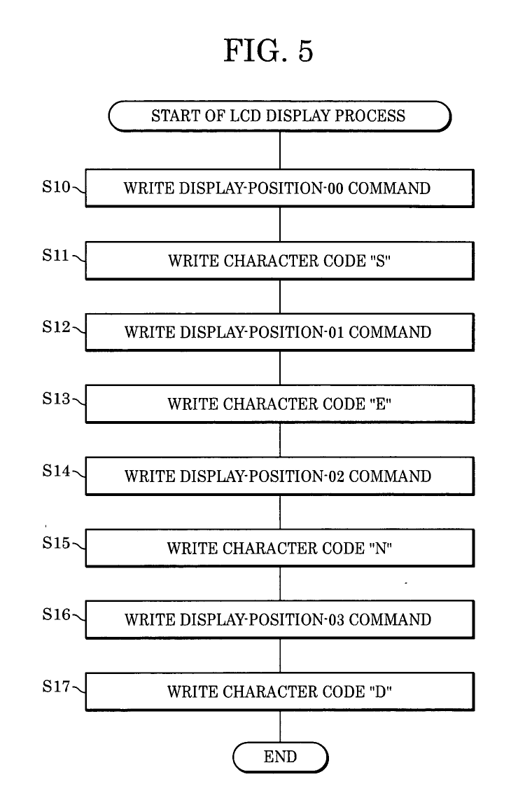

A process of displaying “SEND” in alphabet font on the display module 70 is described next. FIG. 5 is a flowchart illustrating an LCD display process, that is, a process in which the CPU 3 writes font data (for “SEND” in the display module 70. In step S10, the CPU 3 writes, in the display module 70, a display-position command (display-position-00 command) designating display digit 00 on the screen of the liquid crystal display unit 80. In step S113 (of FIG. 4), when the display module 70 receives the display-position-00 command, address 00 representing display digit 00 is set in the address counter 74 for outputting an address in the display data RAM 76, which represents a display-digit position on the screen of the liquid crystal display unit 80.

In step S11, the CPU 3 writes character data 40H of “S” in the display module 70. Regarding the character data 40H of “S”, in step S114 (of FIG. 4), the data register 73 is used to store display-character data 40H of “S” at address 00 (in the display data RAM 76) which represents display digit 00 indicated by the address counter 74.

Next, the CPU 3 performs displaying display-font data of “E”. In step S12, the CPU 3 writes, in the display module 70, a display-position command (display-position-01 command) designating display digit 01 on the screen of the liquid crystal display unit 80. When the display module 70 receives the display-position-01 command, it sets, in the address counter 74 for outputting an address in the display data RAM 76, which represents a display-digit position on the screen of the liquid crystal display unit 80, address 01 representing display digit 01 (in step S113 of FIG. 4).

In step S13, the CPU 3 writes character data 41H of “E” in the display module 70. Regarding character data 41H of “E”, the data register 73 is used to store display-character data 41H of “E” at address 01 (in the display data RAM 76) which represents display digit 01 and which is indicated by the address counter 74 (in step S114 of FIG. 4).

Next, the CPU 3 performs displaying display-font data of “N”. In step S14, the CPU 3 writes, in the display module 70, a display-position command (display-position-02 command) designating display digit 02 on the screen of the liquid crystal display unit 80. When the display module 70 receives the display-position-02 command, address 02 representing display digit 02 is set (in step S113 of FIG. 4) in the address counter 74 for outputting an address in the display data RAM 76, which represents a display-digit position on the screen of the liquid crystal display unit 80.

In step S15, the CPU 3 writes character data 42H of “N” in the display module 70. Regarding character data 42H of “N”, the data register 73 is used to store display-character data 42H of “N” at address 02 (in the display data RAM 76) which represents display digit 02 and which is indicated by the address counter 74 (in step S114 of FIG. 4).

Next, the CPU 3 performs displaying display-font data of “D”. In step S16, the CPU 3 writes, in the display module 70, a display-position command (display-position-03 command) designating display digit 03 on the screen of the liquid crystal display unit 80. When the display module 70 receives the display-position-03 command, address 03 representing display digit 03 is set (in step S113 of FIG. 4) in the address counter 74 for outputting an address in the display data RAM 76, which represents a display-digit position on the screen of the liquid crystal display unit 80.

In step S17, the CPU 3 writes character data 43H of “D” in the display module 70. Regarding character data 43H of “D”, the data register 73 is used to store display-character data 43H of “D” at address 03 (in the display data RAM 76) which represents display digit 03 and which is indicated by the address counter 74 (in step S114 of FIG. 4).

The above processing (of FIG. 5) sets up characters to be displayed on the screen of the liquid crystal display unit 80 and positions at which the characters are displayed.

Referring again to FIG. 4, at an LCD display time, in accordance with a display timing signal generated by the timing generating circuit 75 (step S121), the character data written in the display data RAM 76 is output from the display data RAM 76 to the second character generator memory CG2 and the first character generator memory CG1 (step S122).

In this example, since the display setting is configured for the alphabet, the selecting signal CS2 selects the second character generator memory CG2. Thus, the second character generator memory CG2 outputs display-font data of “S” for alphabet display in accordance with the arrangement table shown in FIG. 2 of addresses and font data in the second character generator memory CG2.

The display-font data “S” output from the second character generator memory CG2 is output to the LCD driver circuit 79 (step S123). By outputting the display-font data onto the screen of the liquid crystal display unit 80, the LCD driver circuit 79 displays the character “S” at the position of display digit 0 on the screen of the liquid crystal display unit 80 (step S124).

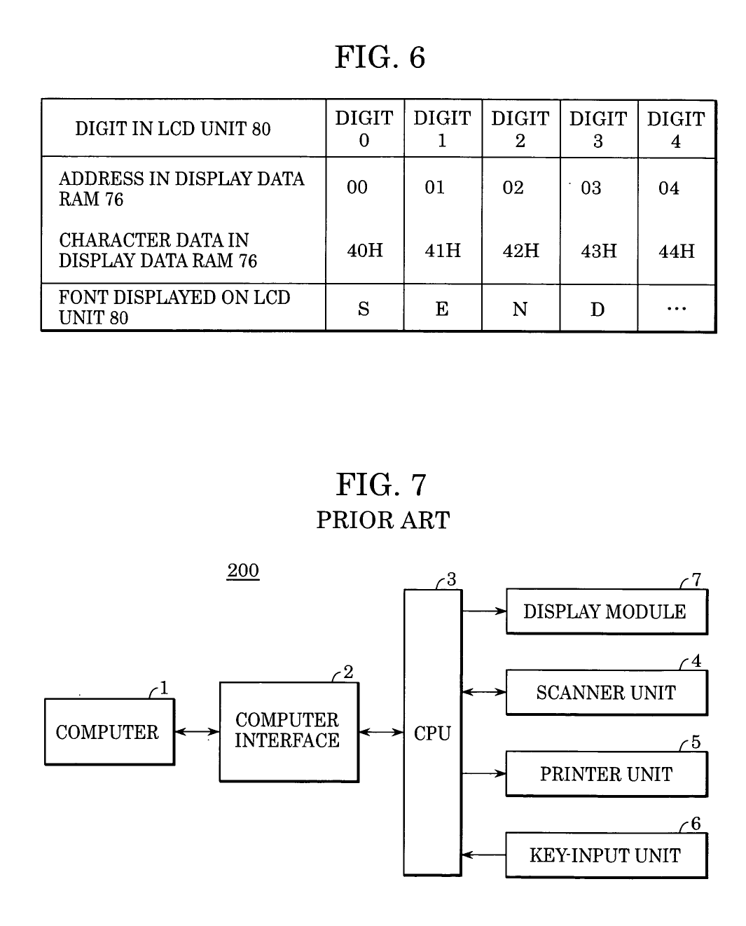

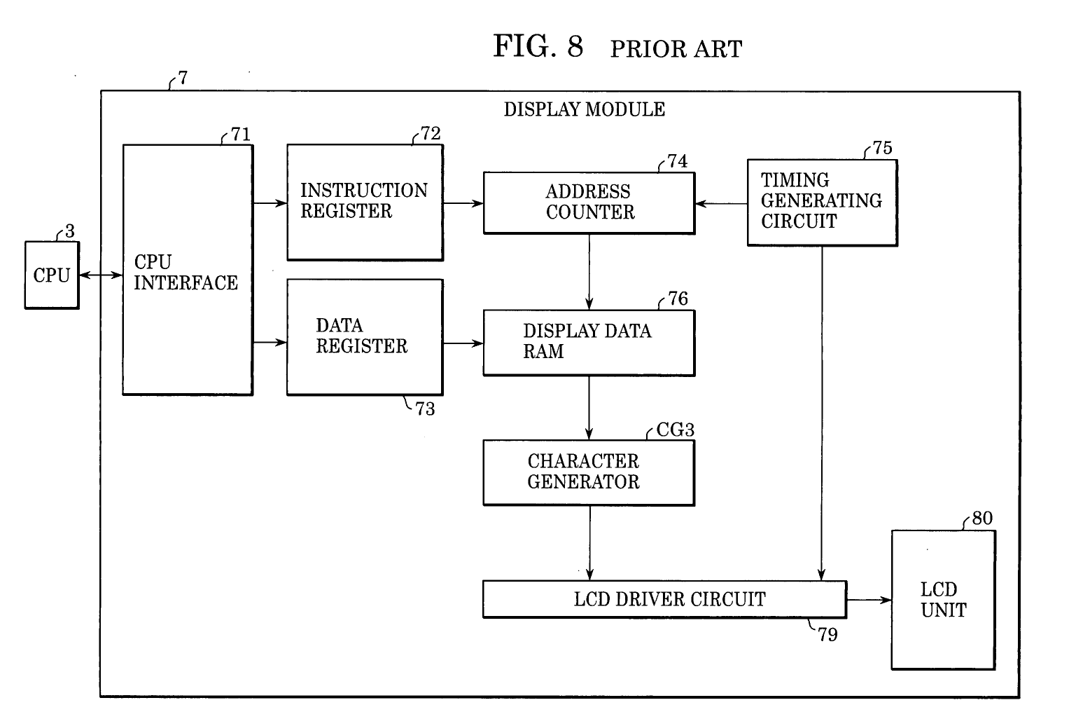

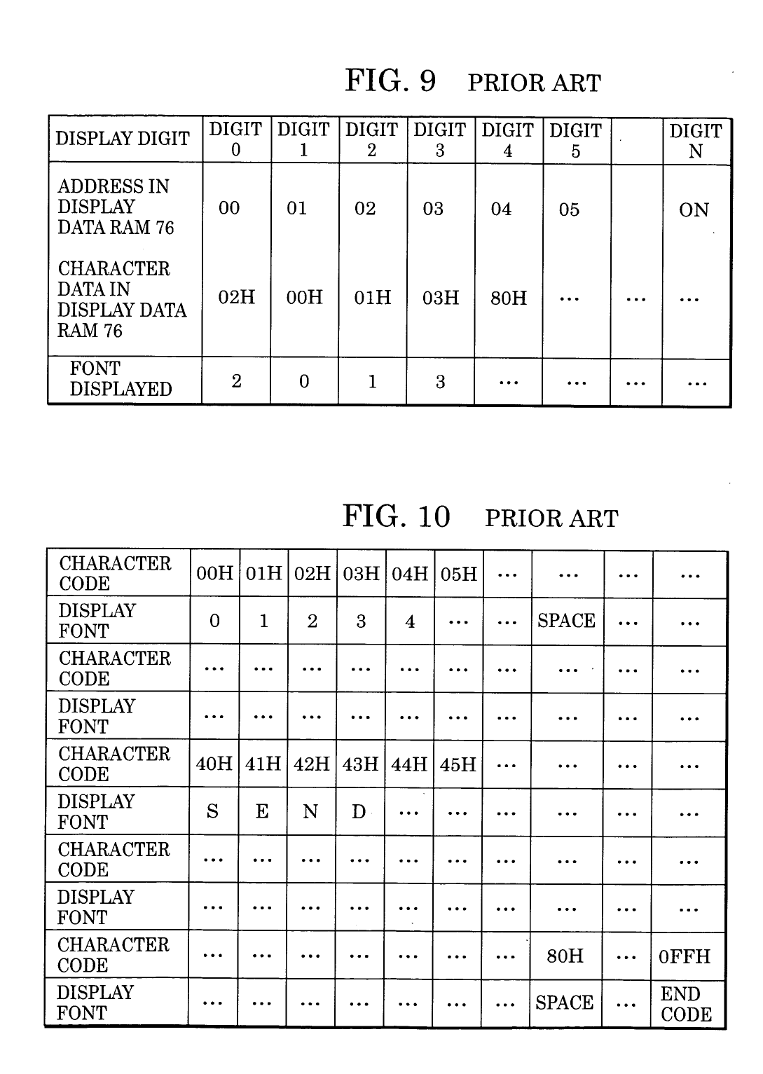

By executing the above processing up to display digit 3, the alphabet font letters “SEND” are displayed at display digits 0 to 3 on the screen of the liquid crystal display unit 80, as shown in FIG. 6.

A case in which the display setting in the liquid crystal display unit 80 is configured for the alphabet by using the key-input unit 6 has been described above. The case of using the key-input unit 6 to configure the display setting in the liquid crystal display unit 80 to the Japanese language is described next. The country code setting is katakana. Following setting the country code to the katakana setting, e.g., via key-input unit 6, it is determined in step S2 (of FIG. 3) that the country code setting is katakana and processing proceeds to step S4 where the LCD display module 70 is set for the katakana font. In response to the Japanese katakana display mode, the display module 70 outputs a selecting signal CS1 for selecting the first character generator memory CG1 (step S111 of FIG. 4). By performing similar display processing, the display module 70 can display Japanese font letters.

In addition, for example, while alphabet letters are being displayed, by using the key-input unit 6 to set the Japanese language, the alphabet display mode can be switched to the Japanese katakana display mode.

In other words, the above embodiment is directed to a display unit having a display section for displaying font characters. The display unit includes a plurality of different memories storing a plurality of character fonts, a selecting-signal input unit for inputting a selecting signal for selecting a desired character font from among the plurality of character fonts, a display controller for controlling the display section to display the character font selected based on the selecting signal input through the selecting-signal input unit.

In this case, the display controller controls the display section to switch the selected character font for display.

The above embodiment is directed to a display-function-provided apparatus having a display section for displaying font characters. The apparatus includes a plurality of different read-only memories storing a plurality of character fonts, a memory selector for selecting a desired read-only memory from among the different read-only memories, and a display controller for controlling the display section to read a character font stored in the read-only memory selected by the memory selector and to display the read character font.

In this case, the above display controller controls the display section to switch the character font to a different character font in response to the selector and to display the different character font. According to the present invention, in the display module 70, character-font generators for a plurality of languages are provided. The character-font generators are switched for driving in response to an input from an external input device, such as an input performed by using a key of an MFP unit, and the liquid crystal display unit 80 performs display. The present invention has advantages in that display modules (for display-function apparatuses) that must be conventionally produced for languages or countries can be made common, and in that an improvement in mass productivity can reduce the production cost. In addition, a CPU processing load can be reduced.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A display unit including a display section for displaying a selected character font, the display unit comprising:
a plurality of different memories, each memory storing a different character font;
selecting-signal input means for inputting a selected input signal for selecting the selected character font from the different character fonts stored in the plurality of different memories; and
display-control means for controlling the display section to display the selected character font selected by the selecting-signal input means based on the selected input signal.

2. The display unit according to claim 1, wherein the display-control means controls the display section to switch the selected character font to a different selected character font and to display the different selected character font.

3. An apparatus including a display section for displaying a character font, the apparatus comprising:
a plurality of different read-only memories, each read-only memory storing a different character font;
memory selecting means for selecting a selected read-only memory from the plurality read-only memories; and
display-section control means for controlling the display section to read the character font stored in the selected read-only memory selected by the memory selecting means and to display the character font read from the selected read-only memory.

4. The apparatus according to claim 3, wherein the display-section control means controls the display section to switch the character font read from the selected read-only memory to a different character font read from a different read-only memory in response to selection by the memory selecting means and to display the different character font read from the different read-only memory.
